(19) United States
(12) Patent Application Publication
(10) Pub. No.: US 2008/0017510 A1
(43) Pub. Date: Jan. 24, 2008

(54) NOx Gas Sensor Method and Device

(76) Inventors: Balakrishnan G. Nair, Sandy, UT (US); Jesse Nachlas, Salt Lake City, UT (US); Michael Middlemas, Murray, UT (US)

Correspondence Address: CERAMATEC, INC., 2425 SOUTH 900 WEST, SALT LAKE CITY, UT, 84119, US

(21) Appl. No.: 11/748,466

(22) Filed: May 14, 2007

Related U.S. Application Data
(63) Continuation-in-part of application No. 11/137,693, filed on May 25, 2005, now Pat. No. 7,217,355.
(60) Provisional application No. 60/574,622, filed on May 26, 2004.

(51) Int. Cl. G01N 27/26

(52) U.S. Cl. 204/424

(57) ABSTRACT

The present invention is an apparatus for determining NOₓ concentration of an exhaust gas stream. The apparatus may include an input assembly capable of receiving the exhaust gas and producing a conditioned output gas. The input assembly includes an oxidizing catalyst structure for oxidizing unburned hydrocarbons and gases to higher oxidation states and an equilibrium structure for establishing a steady state equilibrium concentration ratio between NO and NO₂, said NO₂ concentration between about 0% an about 10% by volume. The apparatus also includes a NOₓ sensor operably connected to the input assembly for receiving the conditioned output gas of the input assembly. The apparatus also includes an oxygen sensor in operable communication with the NOₓ sensor, such that the concentration of the NOₓ present in the exhaust gas can be determined.

This application in a continuation-in-part application claiming benefit to U.S. patent application Ser. No. 11/137,693, filed May 25, 2005 and entitled NOx Gas Sensor Method and Device, which claimed priority to U.S. Provisional Patent Application No. 60/574,622, filed May 26, 2004 and entitled NOx Gas Sensor Method and Device, both of said applications being incorporated by reference herein.

The present invention relates in general to the measurement of NOₓ gases in exhaust streams generated from the combustion of hydrocarbons and particularly the combustion of diesel fuels in cars and trucks.

One known NOₓ sensor is configured as a flat plate multilayer ceramic package design that includes two or more chambers. In the first chamber there are electrodes attached to an oxygen ion conducting electrolyte membrane, thereby forming an oxygen pump to remove the oxygen. In addition, NO₂ is decomposed to NO and one-half O₂. The free oxygen is removed in the first chamber so that theoretically the only gas that enters the second chamber is NO. Another oxygen pump is in the second chamber and is a NO decomposing element that removes the oxygen from the NO. The electrical current produced from the decomposition of NO and the transport of oxygen is correlated to the NO concentration.

There are a number of concerns that affect the commercial application of this known NOₓ sensor. For example, when the NOₓ concentration to be detected is low, there is significant interference from the residual oxygen. In addition, the signal current is very small, thus making it susceptible to electronic noise commonly found in an automobile. Also, the exhaust gas typically has pulsations in the flow rate caused by cylinder firings that influence the ability of the oxygen pump to effectively remove all of the free oxygen and may result in measurement error. This device may also contain a small diffusion hole that limits the passage of gas into the measurement chambers and is prone to clogging.

Another known NOₓ sensor utilizes a similar flat plate multilayer ceramic package design. There are a few differences in the operation principle for this sensor; namely, the sensor is a mixed potential type rather than amperometric, and the use of the first chamber is for converting NO to NO₂ and vice versa. It is a well established phenomenon of mixed potential NOₓ sensors that the voltage signal generated from the gas species NO and NO₂ are of opposite sign, thereby making it difficult to distinguish a meaningful voltage signal in the presence of both gases. Some sensors have attempted to overcome this problem by utilizing the flat plate multilayer package type design with two separate chambers built into the design. Attempts have also been made to convert all of the NOₓ gas species into a single species with the use of an electrochemical oxygen pump that pumps oxygen into the first chamber—thereby converting all of the gas to NO₂—or conversely by removing oxygen from the chamber and reducing all of the NO₂ to NO. This conditioned gas then passes into the second chamber where the NOₓ concentration is measured by the voltage signal generated from a mixed potential type sensor. p There are a number of limitations to this approach that have hampered the commercialization of this configuration. One significant concern is the reproducibility of the conversion system to completely convert all the NOₓ gases into a single species under varying gas concentration conditions. In addition, the oxygen pump conversion cell tends to degrade with time, further contributing to the issue of reproducibility. Because the effects of these concerns are magnified in the low concentration range, this measurement approach is not well suited for detecting low concentrations of NOₓ gases.

Additional drawbacks common to both of the sensor mechanisms disclosed above stem from the fundamental design of the flat plate ceramic multilayer system. Response times tend to be slow because of the complexity of the device where gas first enters a diffusion port, is conditioned in a first chamber, and then diffuses into a second chamber. Achieving rapid gas exchange that can keep up with the dynamic environment of the engine exhaust is difficult to achieve in these configurations. Also, the corrosiveness of the gas—along with fine particulates—may result in the clogging of the diffusion controlling port, or at the very least, changes in the gas flow dynamics with time. Finally, the pulsations in the gas flow rates due to cylinder firings and the accompanying electrical noise typical of automobiles make it difficult to control and monitor the low voltage and current circuits associated with these devices.

Another known NOₓ sensor utilizes a zeolite catalyst to condition the gas prior to being measured by the sensor. Although this catalyst has been demonstrated to be effective in controlled gas environments, no data has been reported wherein the catalyst has suitably performed in H₂O containing gases. Exhaust gases from combustion processes such as diesel exhaust always contain some H₂O vapor as this is one of the major chemical byproducts of combustion of hydrocarbon fuels along with CO₂. As such, the utilization of the NOₓ sensor incorporating a zeolite catalyst in such applications is limited because of the catalyst's well known instability in the presence of H₂O.

The present invention is directed to a method and apparatus for determining NOₓ concentration of an exhaust gas. The apparatus comprises an input assembly capable of receiving the exhaust gas and producing a conditioned gas output. The input assembly includes at least three of the following stages: a stage including a catalyst structure for converting NH₃ in the exhaust gas to N₂ and H₂O; a stage including a catalyst structure for absorbing SO₂ or H₂S from the exhaust gas; a stage including a catalyst structure for oxidizing hydrocarbons and gases to higher oxidation states; and a stage including a catalyst structure to establish a steady state equilibrium concentration ratio between NO and NO₂. A NOₓ sensor is operably connected to the input assembly and receives the conditioned gas output of the input assembly wherein the concentration of the total NOₓ present can be determined.

A further aspect of the present invention includes the NOₓ sensor including a mixed potential sensor receiving the conditioned gas output and generating a voltage signal being a function of the concentration of the total NOₓ present.

Another aspect of the present invention includes the NOₓ sensor including a porous semi-conductive layer capable of absorbing NOₓ gases wherein a physical property is monitored to determine the concentration of NOₓ present.

A still further aspect of the present invention includes an oxygen senor. The oxygen sensor and the NOₓ sensor cooperate to determine the NOₓ concentration in the exhaust gas.

Yet another further aspect of the present invention includes an electronic system or controller that utilizes a formula and is capable of calculating the NOₓ concentration of the exhaust gas based on a measured oxygen concentration. The electronic system or controller can include a database and a data table, wherein the electronic controller or system, database, or data table cooperate to determine the NOₓ concentration of the exhaust gas as a function of oxygen concentration. The electronic controller may calculate the NOₓ concentration of exhaust gas based on a measured oxygen concentration and an output voltage signal from the NOₓ sensor.

An advantage of the present invention is to overcome the problems commonly associated with mixed potential NOₓ sensors and to provide a sensor useful for measuring total NOₓ concentration in an exhaust gas stream.

Another advantage of the present invention is to provide a catalyst assembly that conditions the exhaust gas prior to entering the sensor(s) whereby the ratio of NO₂/NO is in the range of 0.01-0.10.

A further advantage of the invention is to provide an accurate and reproducible voltage signal that correlates to the total NOₓ concentration in the exhaust gas.

A still further advantage of the present invention is to oxidize any unburned combustibles, e.g., C₃H₆, CH₄, CO, etc; that are typical of an exhaust gas stream, and to remove or reduce the concentration of gases such as SO₂ or H₂S that may interfere with the lifetime performance of the electrode(s) and/or sensor.

Another further advantage of the present invention is to provide a sensor that is capable of measuring NOₓ concentration as low as 1 ppm.

Yet another advantage of the present invention is to incorporate an oxygen sensor within the body of the NOₓ sensor so that oxygen and NOₓ concentrations can be measured simultaneously; thereby enabling the accurate determination of the total NOₓ concentration that is a function of the oxygen concentration.

A still further advantage of the present invention is to provide a voltage output signal that is not influenced by other gas constituents in the exhaust gas, e.g., hydrocarbons, CO, CO₂, SO₂, H₂, NH₃, and H₂O.

Yet a still further advantage of the present invention is to provide a NOₓ sensor having a voltage output signal that is not significantly affected by the presence of SO₂ concentrations up to 100 ppm, and in one embodiment, below 15 ppm.

And yet another advantage of the present invention is to provide a NOₓ sensor capable of measuring total NOₓ concentration in the range of 0.1-1500 ppm, for example in the range from 1-1500 ppm.

Other advantages and aspects of the present invention will become apparent upon reading the following description of the drawings and detailed description of the invention.

### DESCRIPTION OF THE DRAWINGS

FIG. 1 is a schematic representation of one embodiment of the input assembly of the present invention;

FIG. 2 is a schematic representation of one embodiment of the present invention;

FIG. 3 is a graph of data obtained using the embodiment shown in FIG. 2 that demonstrates the relationship between NOₓ concentration and the voltage signal generated by the sensor;

FIG. 4 is a plot of the voltage signal generated with varying concentrations of NOₓ gas in the low concentration range of 1-20 ppm;

FIG. 5 is a graph showing the response time signal of a NOₓ sensor when the NOₓ concentration is varied from 470 ppm to 940 ppm; and,

FIG. 6 is schematic diagram of one embodiment of the present invention depicting an integrated sensor including a single electrolyte tube with two sensing electrodes on the outside of the tube, namely, a NOₓ sensing electrode and an O₂ sensing electrode, along with a single reference electrode on the inside of the tube—included within a housing is the input assembly and heater(s), i.e., an internal dual-zone heating rod.

### DETAILED DESCRIPTION

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

In the following description, numerous specific details are presented to provide a thorough understanding of embodiments of the invention. One skilled in the relevant art will recognize, however, that the invention can be practiced without one or more of the specific details, or with other methods, components, materials, and so forth. In other instances, well-known structures, materials, or operations such as vacuum sources are not shown or described in detail to avoid obscuring aspects of the invention.

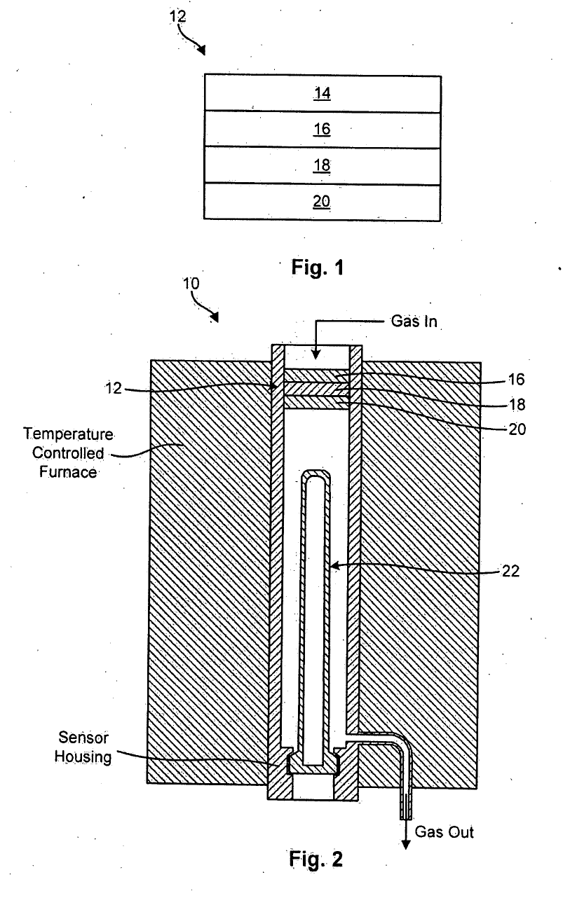

One embodiment of present invention is directed to a method and apparatus for determining NOₓ concentration of an exhaust gas. An apparatus 10 comprises an input assembly 12 (shown in FIG. 1) capable of receiving the exhaust gas and producing a conditioned output gas. The input assembly 12 may include one or more stages including without limitation: a first stage 14 including a first catalyst structure for converting NH₃ in the exhaust gas to N₂ and H₂O (to prevent cross sensitivity); a second stage 16 including a second catalyst structure having an absorbent material for absorbing SO₂ from the exhaust gas; a third stage 18 including a third catalyst structure for oxidizing hydrocarbons (and ammonia) and gases to higher oxidation states; and, a fourth stage 20 including a fourth catalyst structure for establishing a steady state equilibrium concentration ratio between NO and NO₂. It is to be understood that the sequence of stages within the input assembly 12 is not limited to any specific order. As used herein throughout, “first stage” in interchangeable with “converting stage,” “second stage” is interchangeable with “absorber stage” or “absorbent stage,” “third stage” is interchangeable with “oxidizing stage,” and “fourth stage” is interchangeable with “equilibrium stage.” Similarly, “first catalyst structure” is interchangeable with “converting catalyst structure,” “second catalyst structure” is interchangeable with “absorber catalyst structure,” “third catalyst structure” is interchangeable with “oxidizing catalyst structure” and “fourth catalyst structure” is interchangeable with “equilibrium catalyst structure” or “equilibrium structure.”

FIG. 2 depicts an embodiment of the present invention to achieve an accurate measurement of total NOₓ concentration in a gas stream. A NOₓ sensor 22 is operably connected to the input assembly 12 and receives the conditioned output gas from the input assembly wherein the concentration of the total NOₓ present can be determined. In this embodiment, the exhaust gas passes through a three-stage input assembly 12. The initial stage 16 shown in FIG. 2 includes a catalyst structure including an absorbent material such as CaO, MgO, or a compound from the spinel or perovskite group of materials that serve the function of removing SO₂ from the exhaust gas stream. The absorbent material can be in the form of a packed pellet or infiltrated support that may be periodically replaced during servicing without disassembling the rest of the apparatus 10.

The catalyst structure of the next stage 18 of the input assembly 12 shown in FIG. 2 includes an oxidation catalyst, which may include material including at least one of RuO₂, CoO, Co₂O₃, Co₃O₄, Pt, Ni, and Ag which functions to oxidize hydrocarbons and convert CO to CO₂. In one embodiment, the oxidation catalyst oxidizes unburned hydrocarbons. The final stage 20 of the input assembly 12 shown in FIG. 2 a catalyst structure including a silver metal configured as a mesh or a coating on a ceramic substrate that acts to establish a steady state concentration ratio between NO and NO₂ wherein the NO₂ percentage of the total NOₓ gas present may be in the range of 0-10%. For example, in one embodiment the range of NO₂ percentage of the total NOₓ gas present is between about 0% and about 5%.

The equilibrium structure may include one of the group chosen from Ag, Pt, Pd, Rh, and RuO₂ to name a few.

After the exhaust gas has been conditioned by the input assembly 12, it passes to a NOₓ sensor cavity, which in one embodiment includes a mixed potential sensor 22. As the conditioned output gas is received by the mixed potential sensor, the mixed potential sensor generates a voltage signal is generated from which a concentration of NOₓ can be determined in an exhaust gas.

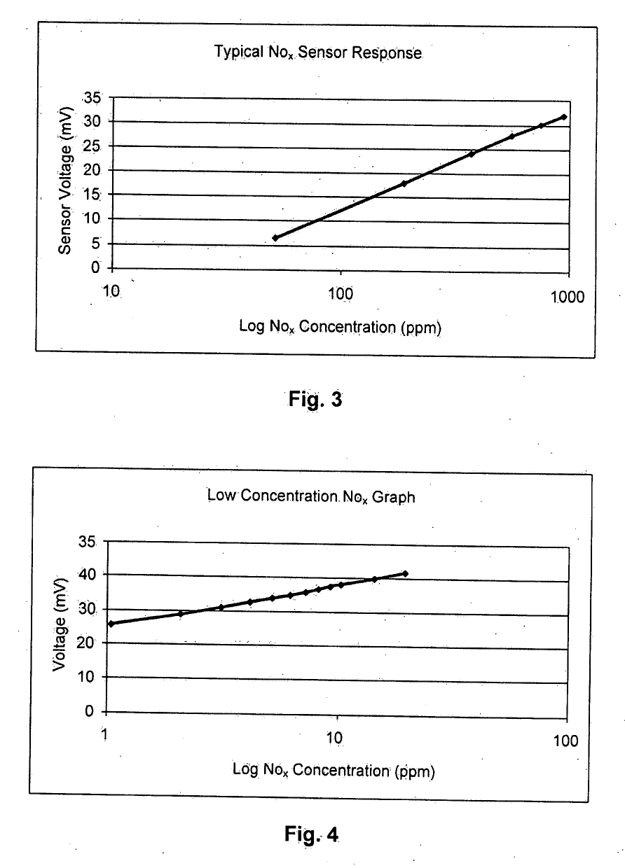

The mixed potential voltage signal is a function of the concentration of the total NOₓ present. FIGS. 3 and 4 depict typical graphs of voltage with respect to the logarithm of the total NOₓ concentration—in the range of 10-1000 ppm (FIG. 3), and 1-20 ppm (FIG. 4)—and is independent of the NOₓ gas species that enter the apparatus 10. In some aspects of the present invention, the voltage signal will be proportional to the logarithm of the NOₓ concentration; while it may also be possible to construct the apparatus such that in the low NOₓ concentration range, e.g., 1-30 ppm, the voltage output signal will be directly proportional to the NOₓ concentration, i.e., linear dependence.

In another embodiment of the present invention, an oxygen sensor 26 is incorporated with the apparatus 10. Referring to FIG. 6, the oxygen sensor 26 is configured within the housing 24. The input assembly and the NOₓ sensor may also reside within the housing 24. More specifically, FIG. 6 depict an integrated sensor including a single electrolyte tube having two sensing electrodes on the outside of the tube—namely, a NOₓ sensing electrode 22 and an O₂ sensing electrode 26—along with a single reference electrode 30 inside of the tube. In one embodiment, the mixed potential sensor includes a sensing electrode. The sensing electrode of the mixed potential sensor may include a semi-conductive oxide material. The Semi-Conductive oxide material may include at least one compound chose from WO₃, Cr₂O₃, Mn₂O₃, Fe₂O₃, TiO₂, and CO₃O₄. The sensing electrode of the mixed potential sensor may include a multi-component oxide material oxide material. In one embodiment the a multi-component oxide material oxide material is a spinel. In another embodiment the a multi-component oxide material oxide material is a perovskite. For example, the multi-component oxide material may include at least one compound chosen from: NiCr₂O₄, ZnFe₂O₄, CrMn₂O₄, LaSrMnO₃, LaSrCrO₃, and LaSrFeO₃. The sensing electrode may also include at least one element chosen from: Pt, Ag, Au, and Rh. The oxygen sensor 26 and the mixed potential sensor cooperate to determine the NOₓ concentration in the exhaust gas.

Included within the same housing 24 are the input assembly 12 and a heating device, e.g., an internal dual-zone heating rod 28 shown in FIG. 6. The heating device may be affixed with the housing in a number a ways known to one of skill in the art. The heating device may generate a first and second temperature zone, wherein the first and second temperature zones provide environments having a first and second temperature, respectively. The apparatus 10 may include an insulation assembly positioned about the heating device so as to construct the first and second or multiple temperature zones. Such a configuration is capable of performing in gas environments with rapidly changing oxygen concentrations. In one embodiment, the apparatus 10 may include an input assembly capable of receiving the exhaust gas and producing a conditioned output gas, a NOₓ sensor operably connected to the input assembly for receiving the conditioned output gas of the input assembly, and an oxygen sensor in operable communication with the NOₓ sensor, such that the concentration of the NOₓ present in the exhaust gas can be determined. The input assembly may include an oxidizing catalyst structure for oxidizing hydrocarbons and gases to higher oxidation states and an equilibrium structure for establishing a steady state equilibrium concentration ratio between NO and NO₂, where the NO₂ concentration is between about 0% an about 10% by volume. In yet another embodiment, the input assembly includes at least two of the following three stages: a converting stage including a converting catalyst structure for converting NH₃ in the exhaust gas to N₂ and H₂O; a oxidizing stage including an oxidizing catalyst structure for oxidizing hydrocarbons and gases to higher oxidation states; and an equilibrium stage including an equilibrium catalyst structure for establishing a steady state equilibrium concentration ratio between NO and NO₂, said NO₂ concentration between about 0% an about 10% by volume.

An oxygen ion conducting electrolyte membrane may be used for both the oxygen sensor 26 and the NOₓ sensor 22. To improve performance, the oxygen sensor 26 may be located within an environment having a second temperature than the environment wherein the NOₓ sensor 22 resides. The different temperatures or temperature zones may be accomplished by inserting a heating rod 28 inside of a ceramic electrolyte tube, wherein the heating rod shown in FIG. 6 is constructed with two separate temperature zones. Alternatively, a single temperature heating rod can be utilized and the design of the insulation can be modified to control the heat loss to create two or more different temperature zones; or, a heater external to the sensing element can be implemented to produce the desired temperature zones.

In one embodiment, the NOₓ sensor resides within an environment having a first temperature of greater than about 300° C. For example the first temperature may range between about 400° C. and about 700° C. In one embodiment, the first temperature may range between about 450° C. and about 550° C. The second temperature may be different that the first temperature. In one embodiment, the input assembly may also reside within an environment having a second temperature. For example, the input assembly and/or the oxygen sensor may reside within an environment having a second temperature of at least 200° C. For example the second temperature may range between about 450° C. and about 900° C. In one embodiment, the second temperature ranges between about 500° C. and about 750° C. This may result in a rapid response of the oxygen sensor 26 and maximum efficiency of the input assembly 12.

In an embodiment where the input assembly includes a converting stage, the converting stage may reside within an environment having a temperature range of approximately 200-500° C. For example, the converting stage may reside within an environment having a temperature range of approximately 200-500° C. In an embodiment that includes an oxidizing catalyst structure, the oxidizing catalyst structure may include an oxidizing catalyst material capable oxidizing CO to CO₂, H₂ to H₂O, and hydrocarbons to H₂O and CO₂. The oxidizing catalyst material may include at least one material chosen from: RuO₂, Pt, Ni, Ag, CoO, Co₂O₃, and Co₃O₄. The oxidizing catalyst material may also include at least one material chosen from: RuO₂, Pt, Ni, Ag, CoO, Co₂O₃, and Co₃O₄. In an embodiment that includes an equilibrium catalyst structure, the equilibrium catalyst structure may include one material chosen from Ag, Pt, Pd, Rh, and RuO₂.

An additional aspect of the NOₓ sensor 22 design may include the sensor tip protruding approximately one inch into the exhaust gas stream—thereby adhering to the design principles utilized in the widely used lambda oxygen sensor. This configuration facilitates maintaining two distinct temperature zones between the NOₓ sensor 22 portion of the ceramic tube outside of the exhaust manifold and within the sensor body housing—thereby creating enough distance from the oxygen sensor 26 so that the two different temperature zones can be effectively achieved.

Located near the NOₓ sensor 22 electrode is a gas exit port comprising a small diameter stainless steel tube that when connected to some type of suction device (not shown), will draw the exhaust gas stream through the porous input assembly 12, past the oxygen sensor electrode 26, past the NOₓ sensor 22 electrode, and exiting the housing 24. The suction device can be a small air pump, or the gas suction can be accomplished using the vacuum lines commonly implemented in internal combustion engines. It is also contemplated that that the gas suction can be connected to the exhaust gas recirculation system found in newer types of automobiles. Alternatively, the housing 24 can be designed so that a portion of the exhaust gas stream is diverted into the sensor housing thereby passing through the input assembly 12 to the sensing electrode 22. This variation may be achieved by various hole patterns in the tubular sheathing that is part of the metal housing 24. In one embodiment, the housing 24 includes a tubular portion. In another embodiment, the housing 24 is mounted on an exhaust pipe.

In another embodiment of the present invention the apparatus 10 includes an electronic system or controller that utilizes a formula and is capable of calculating the NOₓ concentration of the exhaust gas based on a measured oxygen concentration. The electronic system or controller can include a database and a data table, wherein the electronic controller or system, database, or data table cooperate to determine the NOₓ concentration of the exhaust gas as a function of oxygen concentration. The electronic controller may calculate the NOₓ concentration of exhaust gas based on a measured oxygen concentration and an output voltage signal from the NOₓ sensor.

In one embodiment, the apparatus 10 for determining NOₓ concentration of an exhaust gas may include an input assembly 12 capable of receiving the exhaust gas and producing a conditioned output gas. The input assembly 12 may include an oxidizing catalyst structure for oxidizing unburned hydrocarbons and gases to higher oxidation states. The input assembly 12 may also include an equilibrium structure for establishing a steady state equilibrium concentration ratio between NO and NO₂. The NO₂ concentration may range between about 0% an about 10% by volume. The apparatus 10 may also include a NOₓ electrode 22, which may also be referred to throughout this specification as a NOₓ sensor 22. The NOₓ sensor 22 may be operably connected to the input assembly 12 for receiving the conditioned output gas of the input assembly 12. The apparatus 10 may also include an oxygen sensing electrode 26, which may also be referred to throughout this specification as an oxygen sensor. The oxygen sensor 26 may be in operable communication with the NOₓ sensor 22, such that the concentration of the NOₓ present in the exhaust gas can be determined.

In another embodiment, the apparatus 10 for determining a NOₓ concentration of an exhaust gas, the apparatus may include a housing 24 and a heating device 28 affixed within the housing 24. The heating device 28 may be a heating rod 28. It will be appreciated by those of skill in the art that a number of various heating devices 28 may be used to practice the teachings of this invention. An insulation assembly (not shown) may be positioned about the heating device 28 so as to construct a first temperature zone and a second temperature zone. The apparatus 10 may include an input assembly 12 capable of receiving the exhaust gas and producing a conditioned output gas. The input assembly 12 may reside within the first temperature zone. The apparatus 10 may also include a NOₓ sensor 22 operably connected to the input assembly 12 for receiving the conditioned output gas of the input assembly 12. The NOₓ sensor 22 may reside within the second temperature zone. The apparatus 10 may also include an oxygen sensor 26 in operable communication with the NOₓ sensor 22. The oxygen sensor 26 may reside within the second temperature zone. In one embodiment, the first temperature zone is at least about 300° C. and the second temperature zone is at least about 200° C.

In another embodiment, the apparatus 10 for determining NOₓ concentration of an exhaust gas may include an input assembly 12 capable of receiving the exhaust gas and producing a conditioned output gas. The input assembly 12 may include an equilibrium structure for establishing a steady state equilibrium concentration ratio between NO and NO₂. The NO₂ concentration may range between about 0% an about 10% by volume. The apparatus may include a NOₓ sensor 22 operably connected to the input assembly 12 for receiving the conditioned output gas of the input assembly 12.

In another embodiment, the apparatus 10 for determining NOₓ concentration of an exhaust gas may include an input assembly 12 capable of receiving the exhaust gas and producing a conditioned output gas. The input assembly 12 may include a structure that includes an absorbent material for absorbing SO₂ or H₂S from the exhaust gas. The apparatus 10 may include a NOₓ sensor 22 operably connected to the input assembly 12 for receiving the conditioned output gas of the input assembly 12.

It is to be understood that although the embodiments shown here are based on a tubular geometry design, the concepts that enable the apparatus to perform accurately can also be extended to other design components such as a flat plate ceramic multilayer package design, a single electrolyte disk type design, and so forth.

To further facilitate the understanding of the present invention, several exemplifications of the present invention are provided. It is to be understood that the present invention is not limited to these exemplifications.

### EXAMPLE 1

A NOₓ sensor 22 having a structure of the kind shown in FIG. 2 was constructed of a tubular electrolyte body fabricated by the addition of a binder to a commercially available 8 mole % Y₂O₃ doped zirconia powder. The binder/powder mixture was dispensed into a tooling followed by isostatic pressing at 25,000 psi. The ceramic portion was machined to final dimensions and then sintered at 1475° C. for two (2) hours. Next, the ceramic electrolyte was coated with electrodes. The inside of the tube along with a stripe on the outside of the tube (current collector) were coated with a platinum paste electrode material followed by firing at 1000° C. for one (1) hour. Then, the tip of the tube was coated with a tungsten oxide/zirconia mixture that contacted the platinum stripe current collector so that electrical contact was made. The electrode coating was dried and fired at high temperature to promote good adhesion.

The input assembly 12 was fabricated by using a ⅜″ diameter stainless steel tube as the housing 24. On the gas exit end of the tube, a silver mesh plug was installed by press fitting the plug into the end of the tube. On the upstream gas flow side of the silver plug, 0.5 grams of ruthenium oxide powder was inserted into the stainless steel tube. This powder was lightly compacted by using a rod to press the powder against the surface of the silver mesh plug. Next, 1.0 gram of CaO powder was inserted into the tube and again a rod was used to lightly compact this powder against the ruthenium oxide powder. Finally, a piece of nickel mesh screen was pressed into the tube and compacted against the CaO powder to keep the powders in place.

The apparatus was tested wherein a gas stream would flow first through the input assembly 12 and then to the NOₓ sensor electrode. Gases were mixed together using a four-channel mass flow controller system that enabled changing the NOₓ concentration in the gas stream and measuring the sensor voltage signal. A typical voltage response curve generated by varying the NOₓ concentration between 50-1000 ppm total NOₓ is shown in FIG. 3.

### EXAMPLE 2

A NOₓ sensor fabricated as described in Example 1 was tested at low concentrations of NOₓ gases to demonstrate the low range capability of the present invention. Gases were mixed together using a four-channel mass flow controller system that enabled changing the NOₓ concentration in the gas stream and measuring the sensor voltage signal. A certified gas cylinder with a concentration of 20 ppm NO/balance nitrogen was used for this test. The concentration was varied by mixing this gas cylinder with gases from a nitrogen and oxygen cylinder. The concentration was varied in increments of 1 ppm from 1-20 ppm. A graph showing the voltage output signal as a function of NOₓ concentration is shown in FIG. 4.

### EXAMPLE 3

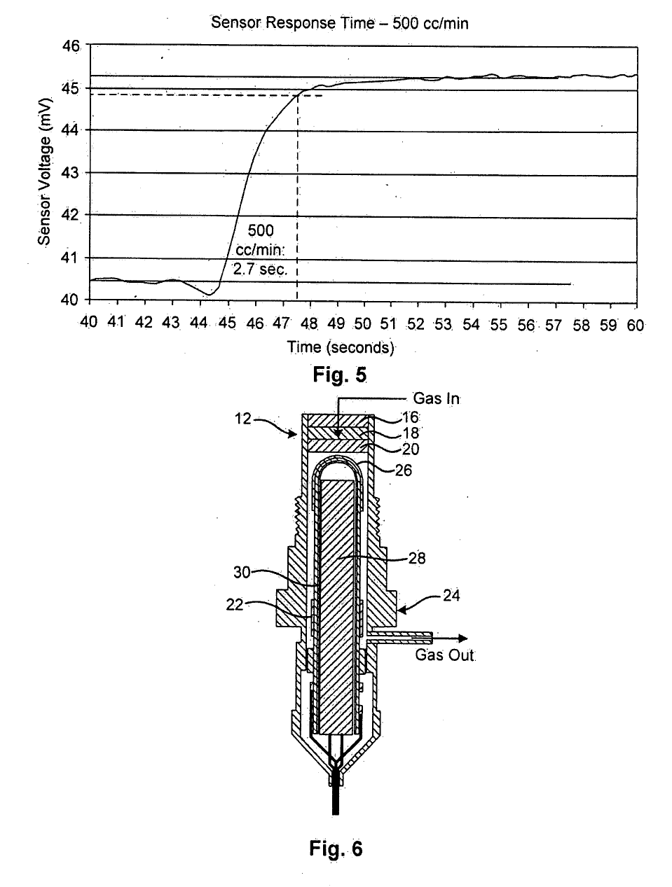

The NOₓ sensor fabricated as described in Example 1 was also tested for sensor response time to demonstrate the apparatus' ability to function as part of a control system in a NOₓ removal device. Gases were mixed together using a four-channel mass flow controller system that enabled changing the NOₓ concentration in the gas stream and measuring the sensor voltage signal. The gas concentration was switched between 470 ppm and 940 ppm NOₓ at a flow rate of 500 cc/min. The voltage signal was monitored continuously using a data acquisition system with a sampling rate of three readings per second. The sensor response time is defined as a 90% step change of the total voltage signal when the concentration of the NOₓ gas is changed. A sensor response time curve is shown in FIG. 5 that indicates a sensor response time of 2.7 seconds when the NOₓ gas concentration is changed from 470 ppm to 940 ppm.

EXAMPLE 4

A combined NOₓ and oxygen sensor was fabricated as shown in FIG. 6. A tubular electrolyte body was fabricated by addition of binder to a commercially available 8 mole % Y₂O₃ doped zirconia powder. The binder/powder mixture was dispensed into a tooling followed by isostatic pressing at 25,000 psi. The ceramic part was machined to its final dimensions and then sintered at 1475° C. for two (2) hours. Next, the ceramic electrolyte was coated with electrodes. The inside of the tube—along with two stripes on the outside of the tube (current collectors) and the oxygen sensing electrode on the tip—were coated with a platinum paste electrode material followed by firing at 1000° C. for one (1) hour. Then, a 1 cm by 1 cm patch on the side of the tube was coated with a tungsten oxide/zirconia mixture that slightly overlapped the platinum stripe current collector so that electrical contact was made. The electrode coating was dried at 80° C. followed by firing at high temperature to promote adhesion.

The input assembly was fabricated by using a ⅜″ diameter stainless steel tube as the housing. On the gas exit end of the tube, a silver mesh plug was installed by press-fitting the plug into the end of the tube. The silver mesh plug was fabricated by cutting twenty-five 0.30″ diameter pieces of eighty (80) mesh silver screen and spot welding them together to form a compact plug. On the upstream gas flow side of the silver plug, 0.5 grams of ruthenium oxide powder was inserted into the stainless steel tube. This powder was lightly compacted by using a rod to press the powder against the surface of the silver mesh plug. Finally, a piece of nickel mesh screen was pressed into the tube and compacted against the RuO₂ powder to keep the powder in place.

While specific embodiments of the present invention have been illustrated and described, numerous modifications come to mind without significantly departing from the spirit of the invention, and the scope of protection is only limited by the scope of the accompanying claims.

What is claimed is:

1. An apparatus for determining NOₓ concentration of an exhaust gas, the apparatus comprising:
an input assembly capable of receiving the exhaust gas and producing a conditioned output gas, the input assembly comprising:
an oxidizing catalyst structure for oxidizing unburned hydrocarbons and gases to higher oxidation states; and
an equilibrium structure for establishing a steady state equilibrium concentration ratio between NO and NO₂, said NO₂ concentration between about 0% an about 10% by volume;
a NOₓ sensor operably connected to the input assembly for receiving the conditioned output gas of the input assembly; and
an oxygen sensor in operable communication with the NOₓ sensor, such that the concentration of the NOₓ present in the exhaust gas can be determined.

2. The apparatus of claim 1, wherein the oxidizing catalyst structure comprises at least one material chosen from RuO₂, Pt, Ni, Ag, CoO, Co₂O₃, and Co₃O₄.

3. The apparatus of claim 1, wherein the equilibrium structure comprises one of the group chosen from Ag, Pt, Pd, Rh, an RuO₂.

4. The apparatus of claim 1, wherein the NOₓ sensor resides within an environment having a first temperature of greater than 300° C.

5. The apparatus of claim 1, wherein the oxygen sensor and input assembly reside within an environment having a second temperature greater than about 200° C.

6. The apparatus of claim 4, wherein the first temperature zone is between about 400° C. and about 700° C.

7. The apparatus of claim 6, wherein the first temperature zone is between about 450° C. and about 550° C.

8. The apparatus of claim 5, wherein the second temperature ranges between about 450° C. and about 900° C.

9. The apparatus of claim 8, wherein the second temperature ranges between about 500° C. and about 750° C.

10. The apparatus of claim 5, wherein the second temperature is greater than about 700° C.

11. The apparatus of claim 1, wherein the NOₓ sensor comprises a mixed potential sensor for receiving the conditioned output gas.

12. The apparatus of claim 11, wherein the mixed potential sensor is configured to generate a voltage signal from which a concentration of NOₓ in an exhaust gas can be determined.

13. The apparatus of claim 11, wherein the mixed potential sensor comprises a sensing electrode.

14. The apparatus of claim 13, wherein the sensing electrode of the mixed potential sensor comprises a semi-conductive oxide material.

15. The apparatus of claim 14, wherein the semi-conductive oxide material comprises at least one compound chosen from: WO₃, Cr₂O₃, Mn₂O₃, Fe₂O₃, TiO₂, and CO₃O₄.

16. The apparatus of claim 13, wherein the sensing electrode of the mixed potential sensor comprises a multi-component oxide material.

17. The apparatus of claim 16, wherein the multi-component oxide material comprises a spinel or perovskite.

18. The apparatus of claim 16, wherein the multi-component oxide material comprises at least one compound chosen from: NiCr₂O₄, ZnFe₂O₄, CrMn₂O₄, LaSrMnO₃, LaSrCrO₃, and LaSrFeO₃.

19. The apparatus of claim 13, wherein the sensing electrode of the mixed potential sensor comprises at least one element chosen from: Pt, Ag, Au, and Rh.

20. The apparatus of claim 1, wherein the NOₓ sensor comprises a porous semi-conductive layer capable of absorbing a NOₓ gas.

21. The apparatus of claim 20, wherein the semi-conductive layer comprises a physical property that can be used to determine the NOₓ concentration in the exhaust gas.

22. An apparatus for determining NOₓ concentration of an exhaust gas, the apparatus comprising;
an input assembly capable of receiving the exhaust gas and producing a conditioned output gas, the input assembly comprising at least two of the following three stages:
a converting stage comprising a converting catalyst structure for converting NH₃ in the exhaust gas to N₂ and H₂O;
a oxidizing stage comprising an oxidizing catalyst structure for oxidizing unburned hydrocarbons and gases to higher oxidation states; and
an equilibrium stage comprising an equilibrium catalyst structure for establishing a steady state equilibrium concentration ratio between NO and NO₂, said NO₂ concentration between about 0% and about 10% by volume; and
a NOₓ sensor operably connected to the input assembly and receiving the conditioned output gas of the input assembly wherein the concentration of the total NOₓ present can be determined.

23. The apparatus of claim 22, wherein the converting stage of the input assembly resides within an environment having a temperature range of approximately 200-500° C.

24. The apparatus of claim 22, wherein the converting stage of the input assembly resides within an environment having a temperature range of approximately 250-400° C.

25. The apparatus of claim 22, wherein the NOₓ sensor resides within an environment having a temperature between about 300° C. and about 700° C.

26. The apparatus of claim 22, wherein the input assembly resides within an environment having a temperature of at least 500° C.

27. The apparatus of claim 22, wherein the oxidizing catalyst structure comprises an oxidizing catalyst material capable of oxidizing CO to CO₂, H₂ to H₂O, and hydrocarbons to H₂O and CO₂.

28. The apparatus of claim 27, wherein the oxidizing catalyst material comprises at least one material chosen from: RuO₂, Pt, Ni, Ag, CoO, Co₂O₃, and Co₃O₄.

29. The apparatus of claim 22, wherein the equilibrium catalyst structure comprises one material chosen from Ag, Pt, Pd, Rh, and RuO₂.

30. The apparatus of claim 22, wherein the NOₓ sensor comprises a mixed potential sensor for receiving the conditioned output gas.

31. The apparatus of claim 30, wherein the mixed potential sensor is configured to generate a voltage signal from which a concentration of total NOₓ in an exhaust gas can be determined.

32. The apparatus of claim 22, further comprising a housing, wherein the input assembly and the NOₓ sensor are located within the housing.

33. The apparatus of claim 32, wherein the housing comprises a tubular portion.

34. The apparatus of claim 32, wherein the housing is mounted on an exhaust pipe.

35. The apparatus of claim 22, further comprising an oxygen sensor located within the housing, the oxygen sensor residing within an environment having a second temperature.

36. The apparatus of claim 22, further comprising a heating device affixed within the housing for generating a first and second temperature zone, wherein the first and second temperature zones provide environments having a first and second temperature, respectively.

37. The apparatus of claim 36, wherein the first temperature and the second temperature are different.

38. The apparatus of claim 22, wherein the NOₓ sensor comprises a porous semi-conductive layer capable of absorbing a NOₓ gas.

39. The apparatus of claim 22, wherein the semi-conductive layer comprises a physical property that can be used to determine the NOₓ concentration in the exhaust gas.

40. An apparatus for determining a NOₓ concentration of an exhaust gas, the apparatus comprising:
a housing;
a heating device affixed within the housing;
an insulation assembly being positioned about the heating device so as to construct a first temperature zone and a second temperature zone;
an input assembly capable of receiving the exhaust gas and producing a conditioned output gas, the input assembly residing within the first temperature zone;
a NOₓ sensor operably connected to the input assembly for receiving the conditioned output gas of the input assembly, said NOₓ sensor residing within the second temperature zone;
an oxygen sensor in operable communication with the NOₓ sensor, said oxygen sensor residing within the second temperature zone;
wherein the first temperature zone is at least about 300° C. and
wherein the second temperature zone is at least about 200° C.

41. The apparatus of claim 40, wherein the first temperature zone ranges between about 400° C. and about 700° C.

42. The apparatus of claim 40, wherein the first temperature zone ranges between about 650° C. and about 750° C.

43. The apparatus of claim 40, wherein the second temperature zone ranges between about 450° C. and about 900° C.

44. The apparatus of claim 40, wherein the second temperature zone ranges between about 500° C. and about 750° C.

45. The apparatus of claim 40, wherein the second temperature zone is greater than about 700° C.

46. The apparatus of claim 40, wherein the NOₓ sensor comprises a mixed potential sensor for receiving the conditioned output gas.

47. The apparatus of claim 46, wherein the mixed potential sensor is configured to generate a voltage signal from which a concentration of the total NOₓ present in an exhaust gas can be determined.

48. The apparatus of claim 40, further comprising a housing, said input assembly and NOx sensor residing within the housing.

49. The apparatus of claim 48, wherein the housing is tubular.

50. The apparatus of claim 46, wherein the oxygen sensor and the mixed potential sensor cooperate to determine the NOₓ concentration in the exhaust gas.

51. The apparatus of claim 40, further comprising an electronic controller for calculating the total NOₓ concentration of exhaust gas based on a measured oxygen concentration and an output voltage signal from the NOₓ sensor.

52. The apparatus of claim 40, wherein the input assembly comprises at least one of a first catalyst structure for converting NH₃ in the exhaust gas to N₂ and H₂O, a second catalyst structure having an absorbent material for absorbing SO₂ or H₂S from the exhaust gas, a third catalyst structure for oxidizing hydrocarbons and gases to higher oxidation states, and a fourth catalyst structure for establishing a steady state equilibrium concentration ratio between NO and NO₂.

53. The apparatus of claim 40, wherein the NOₓ sensor comprises a porous semi-conductive layer capable of absorbing a NOₓ gas.

54. The apparatus of claim 40, wherein the semi-conductive layer comprises a physical property that can be used to determine the NOₓ concentration in the exhaust gas.

55. An apparatus for determining NOₓ , concentration of an exhaust gas, the apparatus comprising:
an input assembly capable of receiving the exhaust gas and producing a conditioned output gas, the input assembly comprising an equilibrium structure for establishing a steady state equilibrium concentration ratio between NO and NO₂, said NO₂ concentration between about 0% an about 10% by volume; and
a NOₓ sensor operably connected to the input assembly for receiving the conditioned output gas of the input assembly.

56. The apparatus of claim 55, wherein the equilibrium structure comprises one of the group chosen from Ag, Pt, Pd, Rh, an RuO₂.

57. The apparatus of claim 55, wherein the NOₓ sensor resides within an environment having a first temperature of greater than 300°0 C.

58. The apparatus of claim 57, wherein the first temperature ranges between about 400° C. and about 700° C.

59. The apparatus of claim 57, wherein the first temperature ranges between about 450° C. and about 550° C.

60. The apparatus of claim 55, wherein the NOₓ sensor comprises a mixed potential sensor for receiving the conditioned output gas.

61. The apparatus of claim 55, further comprising an oxygen sensor in operable communication with the NOₓ sensor effective to determine the concentration of NOₓ present in the exhaust gas.

62. The apparatus of claim 55, wherein the NOₓ sensor comprises a porous semi-conductive layer capable of absorbing a NOₓ gas.

63. The apparatus of claim 55, wherein the semi-conductive layer comprises a physical property that can be used to determine the NOₓ concentration in the exhaust gas.

64. An apparatus for determining NOₓ concentration of an exhaust gas, the apparatus comprising:
an input assembly capable of receiving the exhaust gas and producing a conditioned output gas, the input assembly comprising a structure comprising an absorbent material for absorbing SO₂ or H₂S from the exhaust gas; and
a NOₓ sensor operably connected to the input assembly for receiving the conditioned output gas of the input assembly.

65. The apparatus of claim 64, wherein the equilibrium structure comprises one of the group chosen from Ag, Pt, Pd, Rh, an RuO₂.

66. The apparatus of claim 64, wherein the NOₓ sensor resides within an environment having a first temperature of greater than 300° C.

67. The apparatus of claim 64, wherein the first temperature ranges between about 450° C. and about 900° C.

68. The apparatus of claim 64, wherein the NOₓ sensor comprises a mixed potential sensor for receiving the conditioned output gas.

69. The apparatus of claim 64, further comprising an oxygen sensor in operable communication with the NOₓ sensor effective to determine the concentration of NOₓ present in the exhaust gas.

70. The apparatus of claim 64, wherein the NOₓ sensor comprises a porous semi-conductive layer capable of absorbing a NOₓ gas.

71. The apparatus of claim 64, wherein the semi-conductive layer comprises a physical property that can be used to determine the NOₓ concentration in the exhaust gas.
